(19) United States
(12) Patent Application Publication
(10) Pub. No.: US 2018/0034082 A1
(43) Pub. Date: Feb. 1, 2018

(54) FUEL CELL PURGE SYSTEM AND METHOD

(71) Applicant: FORD GLOBAL TECHNOLOGIES, LLC, Dearborn, MI (US)

(72) Inventor: Daniel E. Wilkosz, Saline, MI (US)

(21) Appl. No.: 15/222,004

(22) Filed: Jul. 28, 2016

(51) Int. Cl. H01M 8/04223; H01M 8/04228; H01M 8/00

(52) U.S. Cl. CPC H01M 8/04231; H01M 8/006; H01M 8/04228

(57) ABSTRACT

A method of operating a fuel cell stack including, prior to shut down, flowing dry purge gas from an inlet port to an outlet port of a fuel cell stack unit cell to purge water from the fuel cell stack and subsequently flowing dry purge gas from the outlet port to the inlet port to further purge water from the fuel cell stack.

### TECHNICAL FIELD

The present disclosure relates to a fuel cell purge system and a method of operating the same.

### BACKGROUND

During fuel cell operation, water is produced as a byproduct. Management of the produced water is critical to fuel cell performance especially during subzero degree Celsius operating conditions. During operation and shutdown, management of produced water is done by forcing/exhausting/pushing the water out through exit channel geometry features and into manifold port openings of a fuel cell stack. Typical water management includes exhausting the water via passageways downstream of the fuel cell stack. These passageways function as a valve which controls release of the water from stack unit cells while maintaining desired operating pressures within the fuel cell stack. But during cold weather operation, any residual water not removed during the fuel cell stack shut down may freeze in the passageways or in other regions of the fuel cell with small cross-sectional areas. The resulting ice formation may cause blockage of at least a portion of the passageways, restricting or preventing the flow of fuel and oxidant, thus inhibiting fuel cell stack operation, especially during start up. Sufficient removal of the water during the fuel cell stack shut down is key to minimizing such ice blockage scenarios.

### SUMMARY

In one embodiment, a method of operating a fuel cell stack is disclosed. The method may include, prior to shut down, flowing a purge gas from an inlet port to an outlet port of a fuel cell stack unit cell to purge water from the fuel cell stack and subsequently flowing the purge gas from the outlet port to the inlet port to further purge water from the fuel cell stack, prevent water blockage formation in outlet channels of the fuel cell stack, or both. The method may further include operating a two way valve to redirect an initial flow of the purge gas from the inlet port to the outlet port to flow in the opposite direction. The method may include releasing the purge gas from the same pressurized reservoir to flow in both directions. Releasing the purge gas may be a discontinuous release in pulses. The method may include breaking up bulk water droplets, water reservoirs, or both to form a film of dispersed water molecules while flowing the purge gas from the outlet port to the inlet port. The fuel cell stack may have a pancake fuel cell stack orientation. The method may include flowing the purge gas from the inlet port to the outlet port for a longer period of time than flowing the purge gas from the outlet port to the inlet port.

In another embodiment, a method of operating a fuel cell stack is disclosed. The method may include repeatedly flowing the purge gas from an inlet port to an outlet port of a fuel cell stack unit cell for a period of time followed by flowing the purge gas from the outlet port to the inlet port to purge water from the fuel cell stack. The method further includes operating a two way valve to redirect an initial flow of the purge gas from the inlet port to the outlet port to flow in the opposite direction. The method may also include releasing the purge gas from the same pressurized reservoir to flow in both directions. Releasing the purge gas may be discontinuous release in pulses. The method may include breaking up bulk water droplets, water reservoirs, or both to form a film of dispersed water molecules while flowing the purge gas from the outlet port to the inlet port. The fuel cell stack may have a pancake fuel cell stack orientation. The method may also include flowing the purge gas from the inlet port to the outlet port for a longer period of time than flowing the purge gas from the outlet port to the inlet port.

In a yet another embodiment, an alternative method of operating a fuel cell stack is disclosed. The method may include repeatedly flowing dry purge gas from an inlet port to an outlet port of a fuel cell stack unit cell for a period of time followed by repeatedly flowing dry purge gas from the outlet port to the inlet port to purge water from the fuel cell stack. The method may include flowing dry purge gas from the inlet port to the outlet port at least twice and subsequently flowing dry purge gas from the outlet port to the inlet port at least twice. The period of time may be about 1 to 15 minutes. The method may further include releasing dry purge gas discontinuously in pulses. The method may also include breaking up bulk water droplets, water reservoirs, or both to form a film of dispersed water molecules while flowing the purge gas from the outlet port to the inlet port. The fuel cell stack may have a pancake fuel cell stack orientation.

### BRIEF DESCRIPTION OF THE DRAWINGS

FIG. 1 depicts an exploded schematic view of an example fuel cell stack cell unit according to one or more embodiments;

FIG. 2 schematically depicts an example unit cell cathode or anode side of a fuel cell bipolar plate and the direction of flow of the purge gas through the fuel cell unit;

FIG. 3A depicts an enlarged schematic view of an outlet channel leading into an open exhaust port depicted in FIG. 2 with water accumulating on the sides of the channel;

FIG. 3B depicts an enlarged schematic view of an outlet channel depicted in FIG. 2 with a bulk water formation obstructing the outlet channel;

FIG. 4 depicts an enlarged schematic view of a plurality of outlet channels with a water droplet formed and residing at the end portion of a rib separating two channels;

FIGS. 5A-5C depict alternative stacking orientations of individual fuel cell units into fuel cell stacks; and

FIGS. 6A-6C depict alternative embodiments of a fuel cell purge system, incorporating a reverse purge cycle, including a fuel cell stack connected to at least one source of purge gas.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except where expressly indicated, all numerical quantities in this description indicating dimensions or material properties are to be understood as modified by the word “about” in describing the broadest scope of the present disclosure.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Fuel cells are devices converting chemical potential energy from a fuel, usually hydrogen, into electrical energy through dissociation of the hydrogen when exposed to a catalyst such as platinum. The fuel cell byproduct of water results from the chemical reaction between the positively charged hydrogen ions, oxygen or another oxidizing agent, and free electrons. Fuel cells are capable of producing electricity as long as they have a continuous source of the fuel and oxygen. Many different types of fuel cells have been developed and are being utilized to power a plethora of different vehicles. Example types of fuel cells include polymer electrolyte membrane fuel cells (PEMFCs), phosphoric acid fuel cells (PAFCs), alkaline fuel cells (AFCs), solid oxide fuel cells (SOFCs), direct methanol fuel cells (DMFCs), molten carbonate fuel cells (MCFCs), etc.

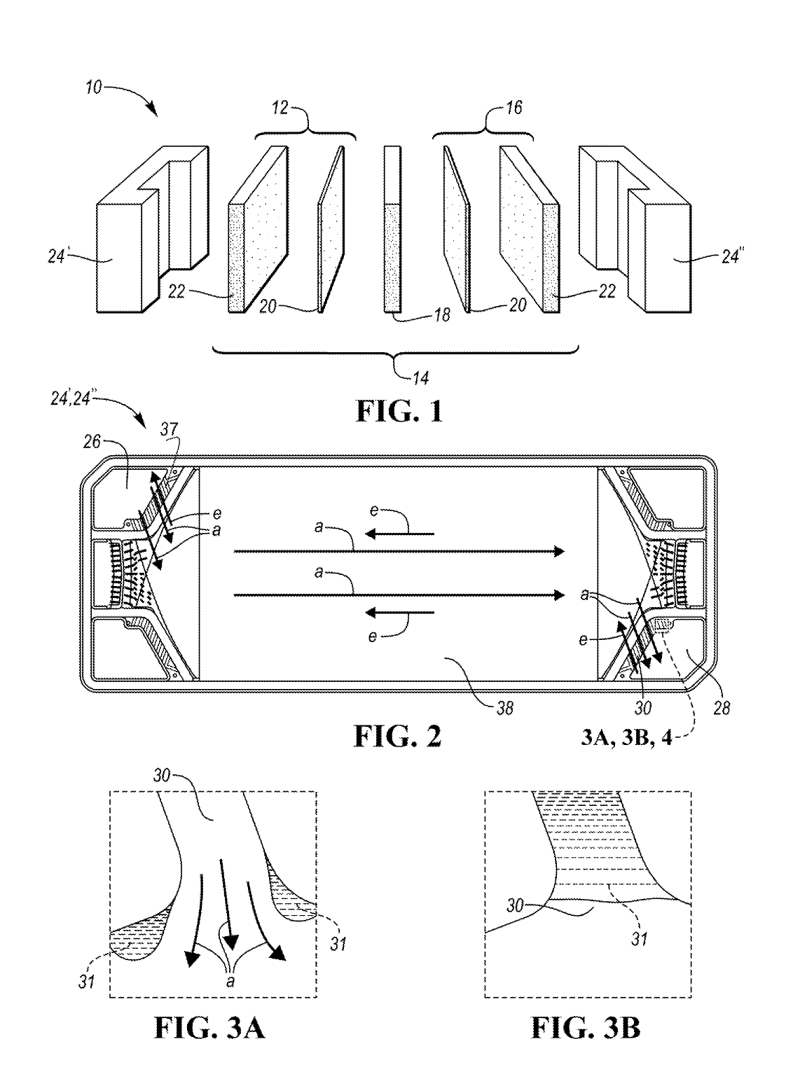

Every fuel cell includes one or more unit cells 10 including several components which are adjacent to each other. An example PEM unit cell 10 is depicted in FIG. 1 and includes an anode side catalyst gas diffusion layer (GDL), also referred to herein as the anode plate or anode plate half 24′, a membrane electrode assembly (MEA) 14, and a cathode side catalyst GDL, also referred to herein as the cathode plate or cathode plate half 24″. An electrolyte is present, transporting electrically charged particles between the two electrodes: the cathode and the anode. Typically, MEA 14 includes a PEM 18, two catalyst layers 20, and two GDLs 22.

As a pressurized fuel enters the fuel cell on the anode side 24′ at the inlet manifold port 26, the fuel undergoes dissociation resulting in positively charged hydrogen ions and electrons. The positively charged hydrogen ions travel through the electrolyte while the electrons travel from the anode bipolar plate 24′ to the cathode bipolar plate 24″, as is depicted in FIG. 1, via an external circuit, thus producing direct current electricity. If alternating current is needed, the direct current output may be routed through an inverter. Oxygen enters the cathode 24″ side of a bipolar plate, combining with electrons returning from the electrical circuit and the hydrogen ions as shown in FIG. 1 to produce water. Alternatively, depending on the type of electrolyte used, the oxygen combined with the electrons may travel through the electrolyte and combine with hydrogen ions at the anode 24′.

During fuel cell operation, as oxygen and hydrogen ions combine, water is produced along with free electrons. The produced water may accumulate at the anode side 24′ and the cathode side 24″ of the fuel cell stack unit cells. The presence of water has the potential for ice formation and is thus an acute concern in cold ambient temperatures below 0° C. If fuel cell purging procedures do not adequately eradicate water from the stack during shutdown, the residual water can freeze, causing ice formation and subsequent gas flow blockages, hindering stack operation and performance especially during cold start up.

Thus, when shut down, residual water in the form of droplets, films, or slugs within a fuel cell stack needs to be exhausted. Typically, the residual water is being removed by purging from the fuel cell stack by flowing a purge gas such as dry hydrogen through the stack unit cells for a pre-determined amount of time. The purge gas is passed through the unit cells 10 from the inlet manifold fuel and gas port 26 openings to the exhaust port 28, forcing water out of the unit cell exhaust port 28. FIG. 2 schematically depicts a plate 24′, 24″ in a horizontal orientation and the direction a of the purge gas flow from the inlet manifold port 26 to the outlet manifold port 28 during purging. But due to capillary action of water, water can collect along unit cell surfaces such as the bipolar plate outlet channels 30 leading to the outlet manifold port 28 openings.

If the purging time is not long enough or the purge gas shear force is not sufficient enough to overcome the surface tension adhesive forces of the water, as the unit cell water is being directed toward the outlet ports 28 during purging, water droplets 31 can collect along the outlet channels 30, accumulate along the outlet channels 30, and fill and/or block portions of or the entire outlet flow path, as is schematically depicted in FIGS. 3A and 3B. FIGS. 3A and 3B show an example outlet channel 30 with water 31 accumulating on the sides of the channel 30 in FIG. 3A and water 31 blocking the entire cavity of the channel 30 in FIG. 3B.

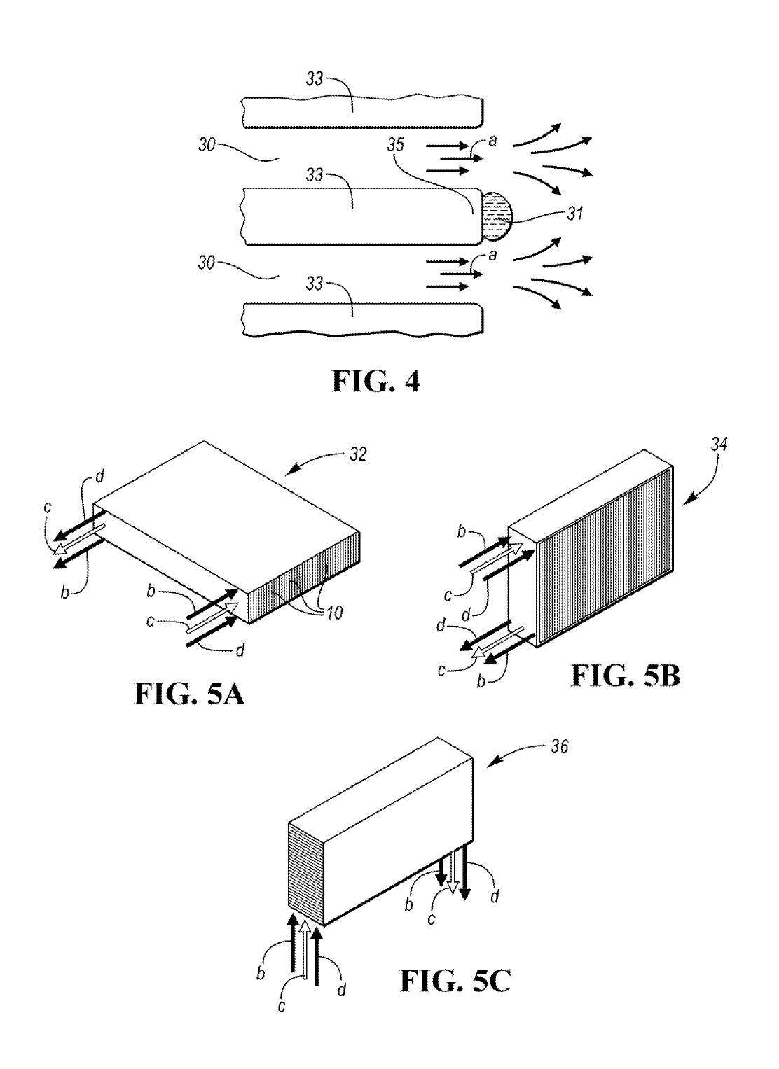

Additionally, water purging is also challenged by interaction of the water 31 with plate 24′, 24″ geometry features. For example, water 31 may deposit and/or collect on side walls, along the side walls, behind the sidewalls, on the channels, in the channels, or a combination thereof of the plate 24′, 24″ features in the purge gas flow direction a and remain there after shut down, as is schematically depicted in FIG. 4. FIG. 4 shows an example portion of the back side of a plate 24′, 24″ having ribs 33 dividing individual outlet channels 30 through which the purge gas flows in the direction a. FIG. 4 further shows a water droplet 31 forming at the end portion 35 of a rib 33 located between two adjacent outlet channels 30.

Thus, to aid in water management during shut down of the fuel cell, water drain or ice drain geometry features may be incorporated into the manifold port 26, 28 openings to aid in drawing water 31 away from the outlet channels 30. The ice drain features tend to be directly adjacent to the inlet and outlet channel openings and can continue along the port opening edges. Typically, the drain features retain water 31 after purging since they are not in the immediate flow path of purge gases and the drain features also rely on gravity and surface tension for water removal. Yet, upon completion of a purge cycle, the drain features forming reservoirs of water 31 as well as any other collected water 31 not completely purged from the fuel cell stack cell units can draw back into the outlet channels 30 or into other plate 24′, 24″ locations by capillary or gravimetric action. When experiencing temperatures of or below 0° C., the water 31 may freeze and form rigid ice blockages to fuel and air flow during startup of the fuel cell. The freeze start condition requires that the fuel cell generates or supplies auxiliary heat to melt the ice prior to being operational. Not only does this delay usage of a fuel cell vehicle, it may also shorten the fuel cell component life or impede initial fuel cell performance characteristics.

The above-described water purging features are typically used for fuel cell stacks configured in horizontal or vertical orientation, schematically depicted in FIGS. 5A and 5B, fuel cell stacks operating using co-flow principles, FIGS. 5A-5C, or counter flow principles. FIG. 5A and FIG. 2 depict a horizontal fuel cell stack 32, FIG. 5B depicts a vertical fuel cell stack 34, and FIG. 5C shows a vertical header fuel cell stack 36. In the FIGS. 5A-5C, b refers to fuel gas flow through the fuel cell stack, c refers to the oxygen/air flow, and d refers to the coolant flow.

The orientation of the horizontal 32 and vertical 34 fuel cell stacks aids in water removal by use of gravity dynamics, i.e. water flows downhill. The vertical header fuel cell stack 36 in which a fuel cell unit is positioned flat on top of an adjacent fuel cell unit may be also referred to as a pancake fuel cell stack. The pancake fuel cell stack includes planar bipolar plates stacked vertically such that the flow fields are horizontal in plane and the headers are vertical. Other than in the port openings, the influence of gravity on water removal in the vertical header fuel cell stack 36 is minimal since the fuel cell units are flat and thus the purging of water becomes more critical to complete. The flat pancake orientation also arrests the advantage of using water drains.

One or more embodiments of the present disclosure provide a method solving one or more of the above-identified problems. To aid in removing water and or to aid in dispersing/distributing residual water within a fuel cell stack unit cell 10 to minimize or eliminate ice formation prior to shut down, a method of operating a fuel cell stack is disclosed. The method includes the use of a reversing purge practice or procedure.

In at least one embodiment, after standard purging procedure of a fuel cell stack during shut down, an additional purge procedure in conducted. The method thus includes flowing a purge gas from an inlet manifold port or inlet port 26 to the outlet manifold port or outlet port 28 of the fuel cell stack cell unit(s) to purge water 31 from the fuel cell stack followed by flowing the purge gas from the outlet port 28 to the inlet port 26 to further purge water from the fuel cell stack, to prevent water blockage formation in outlet channels 30 of the fuel cell stack, or both. The outlet port 28 and the inlet port 26 may refer to the cathode and/or anode inlet and outlet ports.

The addition of the reverse purge cycle may dislodge or displace any residual water remaining at the outlet port 28 of the plate 24′, 24″. The reverse purge cycle within this disclosure refers to flowing of the purge gas from the outlet port 28 to the inlet port 26. The initial purge cycle within this disclosure refers to flowing of the purge gas from the inlet port 26 to the outlet port 28. The dislodged or displaced water may be then forced out of the fuel cell at the inlet port 26. The reverse purge cycle may also distribute or spread any residual water along the plate 24′, 24″ features. In such embodiment, all residual water may be distributed and no water may be forced out of the inlet port 26. Any bulk water accumulation such as a large water droplet or reservoir capable of blocking an outlet channel 30, which may have formed during and/or after the initial purge cycle due to geometry features of the plate 24′, 24″ insufficient purging force, or both, is broken into smaller water units. A large water droplet refers to a water unit of such size that may cause obstruction or blockage of the flow path and or blockage upon freezing. The smaller water units are then distributed or spread along the plate 24′, 24″ features such as the outlet channels 30, inlet channels 37 in the direction e, depicted in FIG. 2, which is opposite to the direction a. The smaller water units may form a thin film. The film may be only as thick as not to obstruct the outlet channels 30, inlet channels 37, and/or the flow path. Upon potential freezing, ice resulting from the thin film would not fully block gas flow.

Alternatively, at least a portion of the water 31 may form smaller water units of such dimensions that do not enable the smaller water units to obstruct gas flow in the channels 30, 37. The smaller water units may be fine water droplets. The force of the reverse purge cycle flow should be sufficient to break any large water accumulation such as the water blockage depicted in FIG. 3B into the smaller water units or to displace the water from the fuel cell unit entirely by forcing the broken water blockage out of the fuel cell via the inlet port 26.

As a result, the amount of water 31 remaining in the outlet and/or inlet channels 30, 37 may be lower than the amount of water present in the fuel cell unit after the initial purge cycle. Alternatively, the amount of water 31 remaining in the outlet channels 30, inlet channels 37 after the reverse purge cycle may be the same, but the distribution of the water 31 within the fuel cell changes sufficiently to ensure that the outlet channels 30, inlet channels 37 are substantially free from one or more water obstructions 31. This additionally means that even if the distributed water freezes, the formed ice does not block the outlet channels 30, inlet channels 37 and the fuel gas flow from the inlet port 26 to the outlet port 28 and/or in the opposite direction is unobstructed. Consequently, freeze start up wait times are eliminated or minimized, thus allowing an immediate usage of the vehicle.

The method may include flowing the purge gas from the outlet port 28 to the inlet port 26 to break up bulk water droplets, water reservoirs, or both for a period of time. The period of time or duration of the reverse purge cycle may be the same or different than the duration of the initial purge cycle. The duration of the reverse purge cycle may be longer or shorter than the duration of the initial purge cycle by about 5 to 100% or more, 10 to 80%, or 30 to 50%. The purge cycle may be twice, three, four, five times as long as the duration of the initial purge cycle or longer. Alternatively, the purge cycle may be twice, three, four, five times as short as the duration of the initial purge cycle or shorter. The purge cycle may last less than about 1 minute to 30 minutes or longer, 5 to 20 minutes, or 10 to 15 minutes.

The reverse purge cycle may be conducted in a variety of manners. For example, the reverse purge cycle may follow immediately after the initial purge cycle. Alternatively, the reverse purge cycle may be conducted after a time delay. The time delay may be about is to 60 minutes.

The purge gas may be any purge gas. For example, the purge gas may be hydrogen, nitrogen, or oxygen, with hydrogen being the most common. The purge gas may be dry gas. The purge gas used in the initial purge cycle may be the same purge gas used in the reverse purge cycle. Just one source of the purge gas may be used for both the initial and the reverse purge cycles. Alternatively, two or more different purge gases, or their mixtures may be used for the initial and reverse purge cycles. The two or more different gases may originate from different sources. The sources may include one or more pressurized reservoirs.

The purge gas may be released continuously or discontinuously during the initial purge cycle, reverse purge cycle, or both cycles. A discontinuous release may include regular or irregular time intervals of no gas release between individual spurts or pulses of released purge gas.

The initial purge cycle and the reverse purge cycle may be repeated. The method thus may include repeatedly flowing a purge gas from the inlet port 26 to the outlet port 28 for a period of time followed by flowing the purge gas from the outlet port 28 to the inlet port 26. Alternatively, the method may include repeatedly flowing a purge gas from the inlet port 26 to the outlet port 28 of the fuel cell stack for a period of time followed by repeatedly flowing the purge gas from the outlet port 28 to the inlet port 26 to purge water from the fuel cell stack unit cell. Both initial and purge cycles may be repeated once, twice, three time, four times, or as many times as is needed to ensure residual water is removed from the fuel cell stack or that bulk water and/or water reservoirs are broken into water droplets to form a film of water molecules dispersed on the plate 24′, 24″ features. The dispersion may be uniform, non-uniform, regular, irregular.

In at least one embodiment, the direction of the purge gas may be switched from the initial purge cycle to the reverse purge cycle anytime during purging. For example, the purge gas may be directed to the outlet port 28 and redirected to the inlet port 26 before the purge gas reaches the outlet port 28. For example, the redirection may occur once the purge gas has traveled ¼, ½, ¾, or the like of the distance from the inlet port 26 to the outlet port 28. The redirection or switch may be conducted one or more times and may be especially useful if the plate 24′, 24″ contains geometry prone to water accumulation along a middle section of the plate 24′, 24″. The redirection may be provided via operation of a valve 40. The valve may be a two way valve or a three way valve. For example, the valve 40 may be a two way valve capable of redirecting the initial flow of the purge gas from the inlet port 26 to the outlet port 28 to the reverse purge flow from the outlet port 28 to the inlet port 26.

The method may include purging the anode side 24″, the cathode side 24″, or both. The initial purge cycle and/or reverse purging of the anode side 24′ and the cathode side 24″ may be provided separately or simultaneously. For example, the initial purging and/or reverse purging of the anode side may be conducted prior to purging of the cathode side. Either the cathode side or the anode side may not be purged or may be purged just by the initial purging cycle. Alternatively, the reverse purge procedure may be the only purge procedure conducted on either the cathode side or the anode side. The cathode side and the anode side may be purged the same or different amount of times. For example, the cathode side may be purged by the initial purging cycle and the reverse purge cycle once while the anode side may be purged by the initial purging cycle and the reverse purge cycle more than once. Alternatively, the cathode side and the anode side may be purged alternatively such that at first the cathode side is initially purged, subsequently the anode side is initially purged, followed by reverse purging of the cathode side and the anode side, either simultaneously or the cathode side first and then the anode side. Other purging configurations are contemplated.

The fuel cell stack system may include a controller 42. The controller 42 may be coupled to one or more actuators (not depicted) configured to open and close the valve(s). The controller 42 may be a controller programmed to start, end, alter, and/or redirect a flow of the one or more purge gases through the fuel cell purge system based on input data. The input data may be provided from sensors, be preprogrammed, or both. The controller 42 may have one or more processing components such as one or more microprocessor units (not depicted) which enable the controller 42 to process the input data. The input data may be based on pressure, voltage, both, or the like detected within the fuel cell stack as a whole and/or in individual cell units. The input data may include real time data. The input data may be provided by sensors continuously or discontinuously.

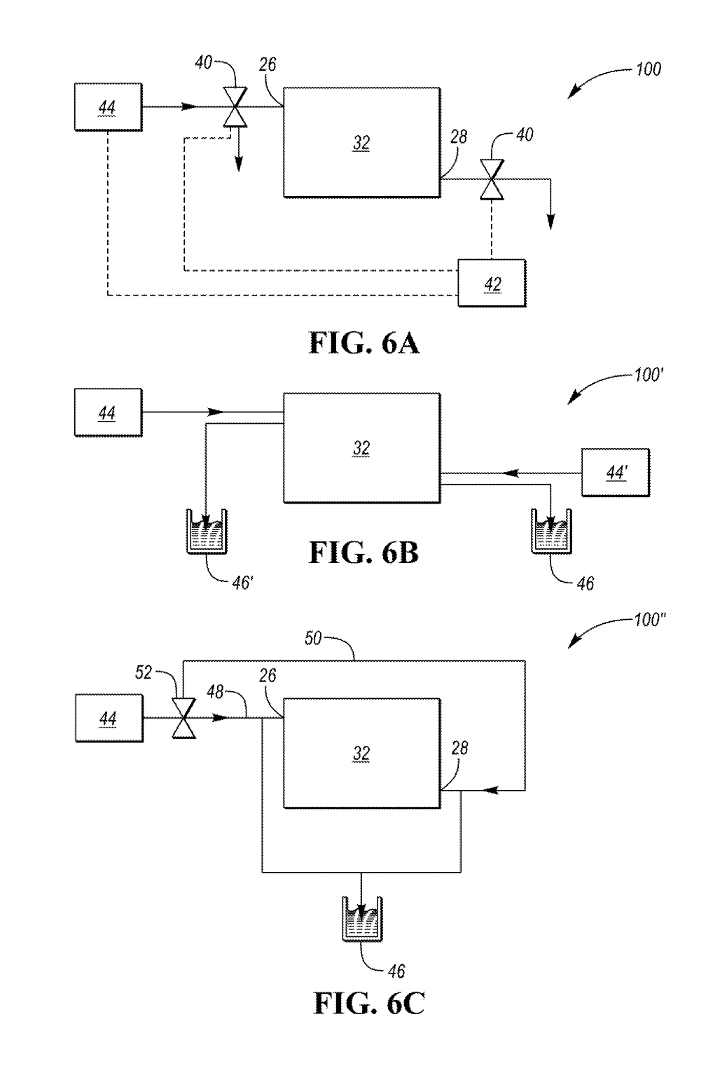

As is depicted in FIG. 6A, the fuel cell stack 32 may be, for illustration purposes only, the horizontal fuel cell stack 32. Yet alternatively, the fuel cell stack may be the vertical fuel cell stack 34 or the vertical header fuel cell stack 36. The fuel cell stack 32 is connected to a source of purge gas 44 which provides the purge gas to flow from the inlet port 26 to the outlet port 28 and in the opposite direction. The fuel cell purge system 100 further includes at least one valve 40 through which the purge gas passes prior to entering the fuel cell stack 32 and after exiting the fuel cell stack 32. The valves 40 enable redirecting the direction of the purge gas flow. The system 100 may further include at least one water collection container into which the water forced out of the fuel cell stack 32 in either direction is accumulated, and from which the water may be further reused or disposed of. Such water containers are depicted in FIGS. 6B and 6C. Alternatively, the purged water may be led into an exhaust system of the fuel cell system 100. The system 100 further includes a controller 42 in communication with the source of gas 44 and the one or two valves 40.

In an alternative example embodiment depicted in FIG. 6B, the fuel cell purge system 100′ includes a primary fuel cell operating purge system including a source of purge gas 44 and a water collection container 46. Alternatively, no water container is included and the water is led to the exhaust of the fuel cell system 100′. The primary purge system provides the initial purge cycle. A secondary fuel cell operating purge system, independent from the traditional fuel cell operating control system, is included. The secondary purge cycle provides the reverse purge cycle. The secondary independent system includes a secondary source of purge gas 44′. The secondary system may also include a secondary water collection container 46. Alternatively, both the primary and secondary purge systems may collect water to a common water collection container 46 and or directly drain from the system as waste. Alternatively still, no water container is included and the purged water is led to the exhaust. While not depicted, a controller 42 in communication with the sources of gas 44, 44′, the primary purge system, the secondary purge system, the one or more water collection containers 46, 46′, or a combination thereof may be included.

In a yet alternative fuel cell purge system 100″ depicted in FIG. 6C, a fuel cell stack 32 is connected to a source of purge gas 44 via piping 48, supplying the purge gas in the direction from the inlet port 26 to the outlet port 28 during the initial purge cycle. The fuel cell stack 32 is also connected to the source of gas 44 via piping 50 enabling flow of the purge gas from the outlet port 28 to the inlet port 26 during the reverse purge cycle. A three way valve 52 is included at the junction of piping 48 and 50. One or more water collection containers 46 may be included. Just as in FIG. 6B, a controller is not depicted. Yet, a controller may be included and may be in communication with the source of gas 44, the valve 52, the one or more water collection containers 46, or a combination thereof.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method of operating a fuel cell stack comprising:
prior to shut down,
flowing a purge gas from an inlet port to an outlet port of a fuel cell stack unit cell to purge water from the fuel cell stack, and
subsequently flowing the purge gas from the outlet port to the inlet port to further purge water from the fuel cell stack, prevent water formation in outlet channels of the fuel cell stack, or both.

2. The method of claim 1, further comprising operating a two way valve to redirect an initial flow of the purge from the inlet port to the outlet port to flow in the opposite direction.

3. The method of claim 1, further comprising releasing the purge gas from the same pressurized reservoir to flow in both directions.

4. The method of claim 1, further releasing the purge gas discontinuously in pulses.

5. The method of claim 1, further comprising breaking up bulk water droplets, water reservoirs, or both to form a film of dispersed water molecules while flowing the purge gas from the outlet port to the inlet port.

6. The method of claim 1, wherein the fuel cell stack has a pancake fuel cell stack orientation.

7. The method of claim 1, further comprising flowing the purge gas from the inlet port to the outlet port for a longer period of time than flowing the purge gas from the outlet port to the inlet port.

8. A method of operating a fuel cell stack comprising:
repeatedly flowing a purge gas from an inlet port to an outlet port of a fuel cell stack unit cell for a period of time followed by flowing the purge gas from the outlet port to the inlet port to purge water from the fuel cell stack.

9. The method of claim 8, further comprising operating a two way valve to redirect an initial flow of the purge gas from the inlet port to the outlet port to flow in the opposite direction.

10. The method of claim 8, further comprising releasing the purge gas from the same pressurized reservoir to flow in both directions.

11. The method of claim 8, further releasing the purge gas discontinuously in pulses.

12. The method of claim 8, further comprising breaking up bulk water droplets, water reservoirs, or both to form a film of dispersed water molecules while flowing the purge gas from the outlet port to the inlet port.

13. The method of claim 8, wherein the fuel cell stack has a pancake fuel cell stack orientation.

14. The method of claim 8, further comprising flowing the purge gas from the inlet port to the outlet port for a longer period of time than flowing the purge gas from the outlet port to the inlet port.

15. A method of operating a fuel cell stack comprising:
repeatedly flowing dry purge gas from an inlet port to an outlet port of a fuel cell stack unit cell for a period of time followed by repeatedly flowing dry purge gas from the outlet port to the inlet port to purge water from the fuel cell stack.

16. The method of claim 15, further comprising flowing dry purge gas from the inlet port to the outlet port at least twice and subsequently flowing dry purge gas from the outlet port to the inlet port at least twice.

17. The method of claim 15, wherein the period of time is about 1 to 15 minutes.

18. The method of claim 15, further releasing dry purge gas discontinuously in pulses.

19. The method of claim 15, further comprising breaking up bulk water droplets, water reservoirs, or both to form a film of dispersed water molecules while flowing dry purge gas from the outlet port to the inlet port.

20. The method of claim 15, wherein the fuel cell stack has a pancake fuel cell stack orientation.
